(19) United States
(12) Patent Application Publication
(10) Pub. No.: US 2014/0356818 A1
(43) Pub. Date: Dec. 4, 2014

(54) SYSTEM AND METHOD FOR TEACHING CHILDREN FINANCIAL LITERACY

(71) Applicant: Jessica Elgin, St. George, UT (US)

(72) Inventor: Jessica Elgin, St. George, UT (US)

(21) Appl. No.: 14/292,821

(22) Filed: May 30, 2014

Related U.S. Application Data
(60) Provisional application No. 61/829,770, filed on May 31, 2013.

(51) Int. Cl. G09B 19/18

(52) U.S. Cl. CPC G09B 19/18
USPC 434/107

(57) ABSTRACT

In an embodiment of the present invention, a system is provided for teaching children financial literacy. The system comprises four educational games: (1) a method for learning about money (“Money Game”); (2) a method for learning about budgeting (“Budget Game”); (3) a method for learning about investing (“Investing Game”); and (4) a method for learning about building a business (“Building a Business Game”).

### CROSS-REFERENCE TO RELATED APPLICATIONS

This application claims the benefit of U.S. Provisional Application Ser. No. 61/829,770, filed on May 31, 2013, which is incorporated herein by reference.

### TECHNICAL FIELD

The present invention relates to educational materials for children and adults. More particularly, the present invention relates to a system and method for teaching children business and financial literacy.

### BACKGROUND

The average millionaire experiments with about 18 different businesses and goes bankrupt about 3.5 times. People in society today frequently overspend and are unable to maintain wealth, regardless of how much they earn. This problem is compounded with advancements in technology, where money is now practically an intangible asset. As such, children often have the misconception that money is merely a card in a parent's wallet or a number on a smartphone—no physical asset is reduced that they can see. By the time children reach adulthood, these mistakes become very costly and may eventually lead them to bankruptcy. There is a need for improved financial learning at home and at school. The present invention seeks to solve these problems.

### SUMMARY OF EXAMPLE EMBODIMENTS

The present disclosure is directed to a system for teaching children financial literacy. The system comprises four educational games: (1) a method for learning about money (“Money Game”); (2) a method for learning about budgeting (“Budget Game”); (3) a method for learning about investing (“Investing Game”); and (4) a method for learning about building a business (“Building a Business Game”).

In another embodiment of the present disclosure, the system further comprises digital resources, including an application for smartphones, computers, or other electronic devices that allows players to learn the system and allows parents to track the player's progress within the system.

In another embodiment, a system further comprises a comic book, or other cartoon, and fictional characters that appeal to children to aid in teaching financial concepts.

In another embodiment, a system further comprises a board game for family interaction and involvement in the learning and teaching process.

In yet another embodiment, a method of implementing the system in a school setting comprises three phases: (1) correlation between risk and reward; (2) basic concepts for operating a business; and (3) basic concepts to build a business.

### BRIEF DESCRIPTION OF THE DRAWINGS

FIG. 1 is an example of a balance sheet as part of the system

FIG. 2 is an example of an invoice as part of the system

### DETAILED DESCRIPTION OF EXAMPLE EMBODIMENTS

The following descriptions depict only example embodiments and are not to be considered limiting of its scope. Any reference herein to “the invention” is not intended to restrict or limit the invention to exact features or steps of any one or more of the exemplary embodiments disclosed in the present specification. References to “one embodiment,” “an embodiment,” “various embodiments,” and the like, may indicate that the embodiment(s) so described may include a particular feature, structure, or characteristic, but not every embodiment necessarily includes the particular feature, structure, or characteristic. Further, repeated use of the phrase “in one embodiment,” or “in an embodiment,” do not necessarily refer to the same embodiment, although they may.

Reference to the drawings is done throughout the disclosure using various numbers. The numbers used are for the convenience of the drafter only and the absence of numbers in an apparent sequence should not be considered limiting and does not imply that additional parts of that particular embodiment exist. Numbering patterns from one embodiment to the other need not imply that each embodiment has similar parts, although it may.

Accordingly, the particular arrangements disclosed are meant to be illustrative only and not limiting as to the scope of the invention, which is to be given the full breadth of the appended claims and any and all equivalents thereof. Although specific terms are employed herein, they are used in a generic and descriptive sense only and not for purposes of limitation. Unless otherwise expressly defined herein, such terms are intended to be given their broad ordinary and customary meaning not inconsistent with that applicable in the relevant industry and without restriction to any specific embodiment hereinafter described. As used herein, the article “a” is intended to include one or more items. When used herein to join a list of items, the term “or” denotes at least one of the items, but does not exclude a plurality of items of the list. For exemplary methods or processes, the sequence and/or arrangement of steps described herein are illustrative and not restrictive.

It should be understood that the steps of any such processes or methods are not limited to being carried out in any particular sequence, arrangement, or with any particular graphics or interface. Indeed, the steps of the disclosed processes or methods generally may be carried out in various different sequences and arrangements while still falling within the scope of the present invention.

The present disclosure is directed to a system and methods for teaching financial literacy. The system comprises four educational games: (1) a method for learning about money (“Money Game”); (2) a method for learning about budgeting (“Budget Game”); (3) a method for learning about investing (“Investing Game”); and (4) a method for learning about building a business (“Building a Business Game”).

A parent or teacher may begin to teach the present system as young as age two. The Money Game is preferably taught between the ages of two and six (2-6) and should be played on a daily basis. The Money Game comprises a poster of pictures of different activities (e.g., school, riding a bike, reading, etc.) and real or fake coins associated therewith. The children begin to gain an understanding of what money looks like, feels like, and that money is a tangible item.

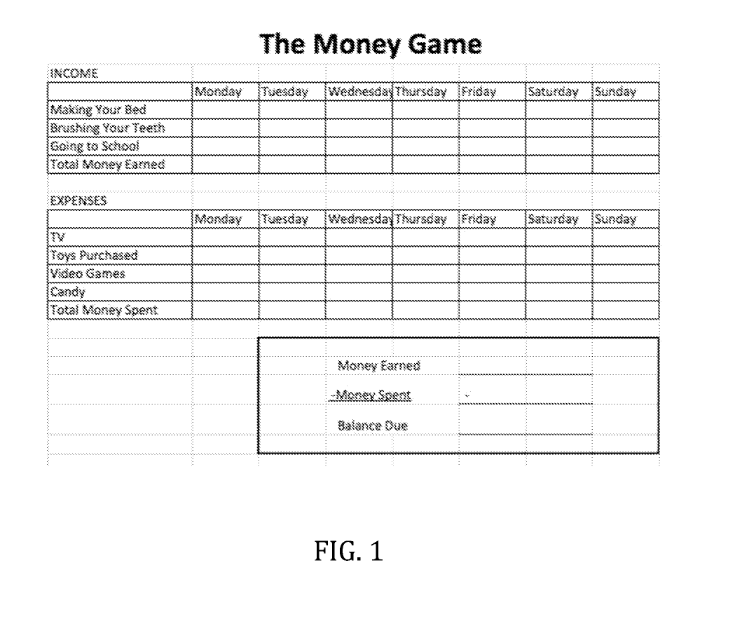

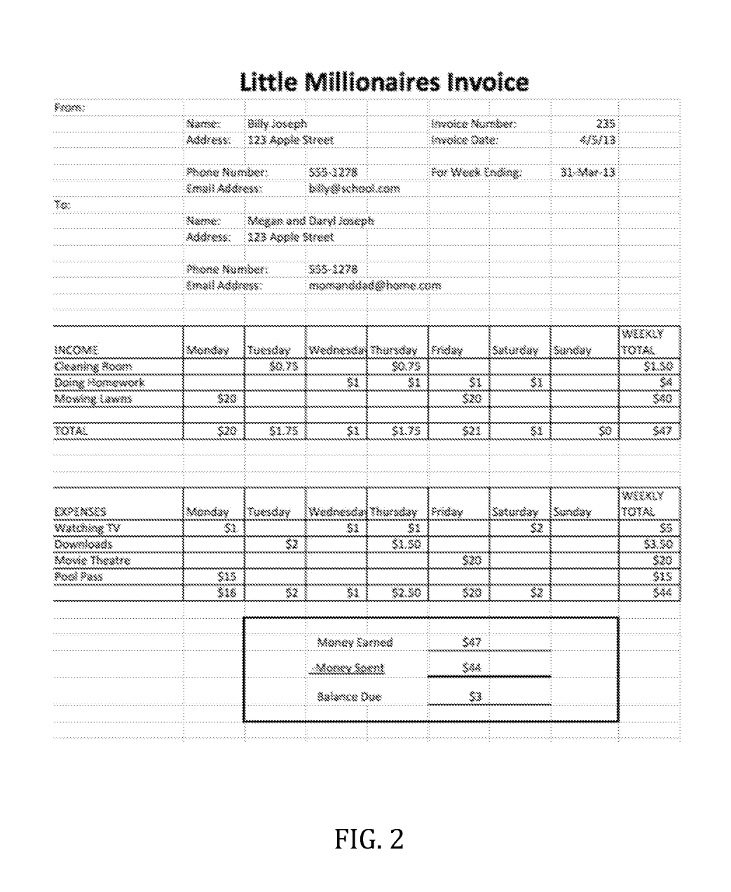

A method of playing the Money Game comprises paying children a nominal amount for “work” completed, such as going to school and doing homework. As an example, and in no way limiting, a parent or teacher would pay a child one dime for going to school and two quarters for doing homework. Further, a child is rewarded for taking risk. For example, perhaps they can ride a scooter, but have a fear of riding a bike. The child would be paid one dime for riding a scooter, but would be paid two dimes for riding a bike. In addition, a child is rewarded for activities that are seen as beneficial (e.g., reading a book), and must pay for activities that a parent or teacher would like to discourage (e.g., playing video games). See FIGS. 1 and 2 for example chart systems.

The Money Game may overlap or otherwise be played at the same time as the Budget Game. The Budget Game comprises a series of coins, preferably in five clear bags, and optionally a fake debit card. Although five clear bags are used as an example here, it will be understood that a different number of bags and/or opacities may be used. In a preferred embodiment, the five bags are labeled with different categories. For example, the categories may be charity, taxes, bills, savings, and play.

A method of playing the Budget Game comprises the adult submitting a monthly invoice to the child for typical items, such as water, rent, transportation, clothing, utilities, food, etc. The invoice should correspond to the amount in the “bills” bag. Further, the child is encouraged to take their money with them on trips to the store so that it may be presented to the parent to buy things. Likewise, if a debit card system is being maintained, the child should have their fake debit card with them and present it to their parent when they would like to make a purchase. The parent then takes the money and/or reduces the balance of the debit card accordingly. In another embodiment, a smartphone or other electronic application may be used to track a child's money. If the child is using the debit card, the money should be removed from the respective bag at the end of the day, so that the child learns that the card removes money from their bags. If the child forgets the money or the card, they are unable to purchase anything.

As a child ages and is capable of higher cognitive ability, usually between the ages of seven and ten (7-10), the Money Game increases in complexity. This phase of the Money Game teaches children that they can increase their revenue by doing more, and that they can decrease their expenses by spending less. A method of teaching the Money Game comprises using a balance sheet, spreadsheet, or similar for keeping track of revenue and expenses, and having the children submit invoices (e.g., FIG. 2) on a regular basis (e.g., weekly) to get paid. This helps a child put a nexus between work completed and revenue earned.

In another embodiment, the Budget Game comprises envelopes or other containers that are divided into categories and marked with percentages. For example, and in no way limiting, the categories may be charity (10%), taxes (30%), bills (30%), savings (5%), investing (10%) and play (15%). A method of teaching the Budget Game comprises giving the child a checkbook to record all transactions and billing the child monthly for their expenses.

In yet another embodiment of the Money Game, preferably for use between ages eleven and fourteen (11-14), children should be given the option of opening an actual bank account. However, they may continue to use the fake account if preferred. Utilizing a fake account may be useful to prevent fees assessed by banks in the event of a child overdrawing an account. A method of playing the Money Game comprises weekly invoicing by the child without encouragement; if no invoice is provided, no payment is given. Parents may also deduct expenses from the payment and list such deductions on the payment.

In another embodiment, the Investing Game is played in conjunction with the Money Game. The investing game comprises a software application for smartphones, computers, tablets, and other electronic devices. The application is further comprised of online checkbook accounting, credit ratings, stock certificates, mortgage loan applications, real estate listings, loans, stocks, CDs, bonds, and similar. It will be understood that one or a variety of categories listed here, or similar, may be used. Each category is in accordance with the industry standard. For example, a standard mortgage loan application may be used. This software application is disconnected from the real world—no actual stocks, loans, real estate, etc. is purchased. In a preferred embodiment, the Investing Game is played over the course of about three months.

In a further embodiment, the Building a Business Game is played in conjunction with the Money Game. The Building a Business game comprises a software application that includes connections to online sites such as eBay®, Amazon®, book publishers, etc. In one embodiment, the software application also comprises a tutorial for getting a business license, SBA loan, and selling items online for actual profits.

In another embodiment of the present invention, the system further comprises a software application for smartphones, computers, or other electronic devices that allows a parent to keep track of the child's income, expenses, and/or monitor their progress in the Money Game, Investing Game, and Building a Business Game. The software application may also be in the form of a website, which may include a newsletter for parents and an online store for purchasing supplies such as balance sheets, invoices, etc. The website may further comprise a child section that includes interactive trivia games, financial walk-through games, and cartoons illustrating financial principles in a manner understood by children.

In another embodiment, a system further comprises a comic book, or other cartoon, and fictional characters that appeal to children to aid in teaching financial concepts. Further the characters may appear at seminars and motivational speaking events in an effort to more fully engage the children.

In yet another embodiment, a system further comprises a board game for family interaction and involvement in the learning and teaching process. The board game comprising two sides for different age levels of play. A first side of the game further comprises store fronts and teaches the concepts of supply management. A second side comprises portfolio management, such as stocks, real estate, etc. In a preferred embodiment, the board game is played in under an hour and is simple enough to engage children while at the same time teaching financial concepts.

In still yet another embodiment, a method of implementing the system in a school setting comprises three phases: (1) correlation between risk and reward; (2) basic concepts for operating a business; and (3) basic concepts to build a business. Schools settings are optimal for this system, as studies often conclude that students are more likely to learn from peers than parents.

In a first phase, a method of teaching Kindergarten and First Graders the correlation between risk and reward comprises paying a student with fake money when a task is completed. For example, paying the student for attending class, doing homework, etc. and charging for desk rent and the like.

In a second phase, a method of teaching second graders through fourth graders the basic concepts for operating a business comprises invoicing, expensing, overhead management, billable goods and services, and allowing children to borrow money with interest. As the children begin borrowing money, they begin to learn about the concept of interest and how buying an item on borrowed money ends up costing them substantially more.

In a third phase, a method of teaching fifth graders basic concepts to build a business comprises invoicing, supply management, and the sales cycle. Further, students must create invoices for income, pay bills, and are given bonuses for creating new business models.

In a further embodiment, a method of implementing the system in schools comprises an assembly, instructional meetings, take-home materials, and a parent guide.

What is claimed is:

1. A method of teaching financial literacy through a system of four educational games, comprising:
a money game which contains visual aids, such as posters or pictures of different common activities, with corresponding monetary values which either earn or cost the player money depending on whether the common activity is to be encouraged or discouraged, such money being either fake or real money;
a budgeting game which contains common items of financial exchange such as coins, paper money, debit cards, credit cards, and other non-financial exchange items to divide expenditures and income into various categories common to finances and budgeting;
an investing game which contains common investing items and information related to those items such as checkbooks, credit ratings, stock certificates, mortgage loan applications, real estate, loans, stocks, bonds, CDs, and similar items according to commonly known industry standards;
a building a business game which contains physical forms and tutorials for business formation, business licenses, business strategies, business plans, and other items in order to help the player learn about how businesses begin, grow, and thrive or fail by selling items, products, or services for profits or losses.

2. The method of claim 1, wherein a game board is used with two sides, a first containing store fronts for teaching supply management and a second side for portfolio management.

3. The money game of claim 1, wherein the game includes balance sheets, spreadsheets, or similar means for keeping track of revenue and expenses and wherein the player submit invoices on a regular basis to get paid.

4. The money game of claim 1, wherein the player is given a bank account, which may be real or fake, where the player learns about banks and banking fees; with a fake account, the parents may impose fees and the player must submit invoices to receive payment.

5. The budgeting game of claim 1, wherein fake or real coins are used and placed into different compartments or bags which are labeled according to their category, such as taxes, bills, savings, charity, and play; the category compartments or bags being receptacles for the fake or real coins which provide a visual aid for educating children on budgeting.

6. The budgeting game of claim 1, wherein the adult submits a monthly bill for necessities (i.e., food, water, rent, transportation, clothing, utilities, etc.) to the player which should be placed in a bill bag or category; the player comparing income to the expenses provided in the bill to calculate the player's net income or net debt.

7. The budgeting game of claim 1, wherein a fake or real debit card system is implemented which the players must take with them to purchase any item so that the players may learn of the correlation between a card and money; the players then reconcile the accounts at the end of the day.

8. The budgeting game of claim 1, wherein containers or envelopes are divided into categories for budgeting.

9. The budgeting game of claim 1, wherein a player records transactions in a checkbook and where the player is invoiced and pays for monthly expenses.

10. The investing game of claim 1, wherein the investing categories are learned and played in a quarterly or semiannual rotation.

11. The building a business game of claim 1, wherein fake or real business entities are formed and players attempt to earn profits based on each player's preferred business model.

12. The system of teaching financial literacy of claim 1, wherein some or all of the games are played using digital interactivity in the form of internet-based or stand-alone applications for smartphones, computers, or other electronic devices.

13. A method of teaching financial literacy using electronic devices, the method comprising using programs, applications, or other software to track a student's income, expenses, and account balances;

14. The method of claim 13, wherein a player uses a fake debit or credit card in connection with the program, application, or other software.

15. The method of claim 13, wherein the player receives daily notifications regarding account balance status.

16. A method of teaching financial literacy in a school setting, comprising:
a first phase teaching a correlation between risk and reward;
a second phase teaching basic concepts for operating a business;
a third phase teaching basic concepts to build a business.

17. The first phase of claim 16, wherein students use fake money performing tasks with various risks and rewards, with a greater risk correlating to a potentially greater reward.

18. The second phase of claim 16, wherein students learn basic concepts for operating a business, comprising invoicing, expensing, overhead management, billable goods and services, and borrowing with interest.

19. The third phase of claim 16, wherein students learn to build a business comprising invoicing, supply management, sales, marketing, creating invoices, paying bills, and where students are given bonuses for developing new or unique business models.

20. The method of teaching financial literacy in a school setting of claim 16, wherein materials are provided for financial literacy in assemblies, instructional meetings, take-home materials, student guides, and parent guides.
